(19) United States
(12) Patent Application Publication
(10) Pub. No.: US 2014/0167490 A1
(43) Pub. Date: Jun. 19, 2014

(54) VEHICLE RIM PROTECTION DEVICE

(71) Applicant: Seung Joo Roh, Seoul (KR)

(72) Inventor: Seung Joo Roh, Seoul (KR)

(21) Appl. No.: 13/713,370

(22) Filed: Dec. 13, 2012

(51) Int. Cl. B60B 7/01

(52) U.S. Cl. CPC B60B 7/01
USPC 301/37.24

(57) ABSTRACT

A device for protecting a rim of a vehicle/conveyance such as a bicycle, a motorcycle, an automobile, etc. is provided. In general, the device includes a ring for abutting and protecting an outside edge (along an outer circumference) of a rim, and a plurality of wings for securing the ring to the rim via insertion of the wings between the rim and a tire mounted on the rim. In one embodiment, the ring and/or each wing may be made of one or more materials such as a rubberized material, a plastic material, a composite material, or any combination thereof. Moreover, each wing typically comprises a wedge shape body having a set of engagement peaks for inserting and securing the wings between the tire and the wheel (e.g., before or after the tire has been mounted on the rim).

### FIELD OF THE INVENTION

The present invention generally relates to a rim protection device. Specifically, the present invention relates to a rim/wheel protection device for protecting the rims of conveyances/vehicles such as bicycles, motorcycles, and/or automobiles.

### BACKGROUND OF THE INVENTION

Vehicle rim damage has long been an issue for vehicle operators. This issue is especially heightened as interest in vehicle rim aesthetics plays a greater role in a vehicle's external appearance. As such, besides traditional aluminum rims, diverse types of automobile tire rims such as magnesium and carbon are entering the market. That is, there has been an increased attention on rims with added polish.

Even with diverse types of wheel cover products designed for rim protection in the current market, such products pose a great degree of inconvenience by not only requiring various binding mechanisms such as screws that are difficult to install/uninstall, but also presenting technical limits with wheel covers that cover the wheel entirely (thus adding to the vehicle weight and defeating the design aesthetics of rims). A high percentage of the damage inflicted on wheel finishes is caused by contact with objects such as a curb. That is, many of today's wheels have edges that protrude beyond the edge of the tire, or spokes that curve outward past the rim edge. This makes it all too easy to sustain damage commonly called “curb rash.” An example of such rim damage is shown in FIG. 1. Specifically, FIG. 1 depicts a rim/wheel 10 having a damaged portion 12 (e.g., due to contact with a curb). As can be seen, this damage is not generally repairable and typically requires a vehicle owner to acquire a new rim.

Heretofore, attempts have been made to prevent rim damage.

U.S. Pat. No. 5,967,212 discloses a wheel rim protector including an annular main portion having a pair of spaced apart side walls and a base wall connecting the side walls together. The side walls of the main portion define an annular channel between them which is adapted for receiving an outer lip of a wheel rim therein.

Published U.S. Patent Application No. 2007/0290548 discloses a wheel rim protector comprising a main component that provides wheel rim protection and one or more clamping assemblies for affixing the rim protector to the wheel rim. The rim protector specifically protects the interface between the rim bead and the tire bead, and need not cover a large portion of the wheel rim or tire sidewall in order to be effective.

Published U.S. Patent Application No. 2010/0171362 discloses a wheel protector comprising a generally circular annulus having an axis defining radial and axial directions, the rim protector comprising a tail portion sized to fit in use between the wheel and a tire fitted to the wheel, and a head portion, the head portion being wider than the tail portion, the tail portion extending away from the head portion, in which, when the rim protector is fitted to a wheel such that the tail portion is held between the wheel and the tire and the head portion abuts a rim of the wheel, the head portion overlaps the rim and extends further radially over the rim than it does over the tire.

Published U.S. Patent Application No. 2011/0304196 discloses a wheel rim protector comprising a base having an external face and an internal face, the external face comprising a curved profile and a side-wall extending from a first side of the base.

Unfortunately, none of these attempts provide a way to easily retrofit an effective rim protection device onto a vehicle.

### SUMMARY OF THE INVENTION

In general, aspects of the present invention generally relate to a device for protecting a rim of a vehicle/conveyance such as a bicycle, a motorcycle, an automobile, etc. In general, the device includes a ring for abutting and protecting an outside edge (along an outer circumference) of a rim, and a set (e.g., at least one) of wings for securing the ring to the rim via insertion of the wings between the rim and a tire mounted on the rim. In one embodiment, the ring and/or each wing may be made of one or more materials such as a rubberized material, a plastic material, a composite material, or any combination thereof. Moreover, each wing typically comprises a wedge shape body having a set of engagement peaks for inserting and securing the wings between the tire and the wheel (e.g., before or after the tire has been mounted on the rim).

A first aspect of the present invention provides a device for protecting a rim of a conveyance, comprising: a ring; and a set of wings affixed to the ring, wherein the set of wings are configured to engage between the rim of the conveyance and a tire of the conveyance to secure the ring to the rim after the tire has been mounted on the rim, and wherein at least a portion of the device comprising a rubberized material having an elasticity factor.

A second aspect of the present invention provides a device for protecting a rim of a conveyance, comprising: a ring; and a plurality of wings affixed to the ring, wherein the plurality of wings are configured to engage between the rim of the conveyance and a tire of the conveyance to secure the ring to the rim after the tire has been mounted on the rim, and wherein the plurality of wings comprise a wedge shape body having a set of engagement peaks for inserting and securing the plurality of wings between the tire and the wheel.

A third aspect of the present invention provides a device for protecting a rim of a conveyance, comprising: a ring; and a plurality of wings affixed radially to the ring, wherein the plurality of wings are configured to engage between the rim of the conveyance and a tire of the conveyance to secure the ring to the rim after the tire has been mounted on the rim, wherein the plurality of wings comprise a wedge shape body having a set of engagement peaks for inserting and securing the plurality of wings between the tire and the wheel, and wherein at least a portion of the plurality of wings comprising a rubberized material having an elasticity factor.

### BRIEF DESCRIPTION OF THE DRAWINGS

These and other features of this invention will be more readily understood from the following detailed description of the various aspects of the invention taken in conjunction with the accompanying drawings in which:

FIG. 1 shows rim damage to be prevented by a protection device according to an embodiment of the present invention.

FIG. 2 shows components of a rim according to an embodiment of the present invention.

FIGS. 3A-B show components of a tire according to an embodiment of the present invention.

FIG. 4 shows a protection device to be secured between a rim and a tire according to an embodiment of the present invention.

FIG. 5 shows a view of the protection device of FIG. 4 as installed between a rim and a tire according to an embodiment of the present invention.

FIG. 6 shows the protection device of FIG. 4 having a protective shell according to an embodiment of the present invention.

FIG. 7 shows the protection device of FIG. 4 having varying materials to improve device integration and performance according to an embodiment of the present invention.

FIG. 8 shows a wing of the protection device of FIG. 4 according to an embodiment of the present invention.

FIG. 9 shows wing positions on a ring of the protection device of FIG. 4 according to an embodiment of the present invention.

FIG. 10 shows the insertion point of the wing of the protection device of FIG. 4 with respect to the components of a tire according to an embodiment of the present invention.

FIG. 11 shows an isometric view of the protection device of FIG. 4 according to an embodiment of the present invention.

FIG. 12 shows the protection device of FIG. 4 as installed on a conveyance according to an embodiment of the present invention.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION OF THE INVENTION

Illustrative embodiments will now be described more fully herein with reference to the accompanying drawings, in which embodiments are shown. This disclosure may, however, be embodied in many different forms and should not be construed as limited to the embodiments set forth herein. Rather, these embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Reference throughout this specification to “one embodiment,” “an embodiment,” “embodiments,” “exemplary embodiments,” or similar language means that a particular feature, structure, or characteristic described in connection with the embodiment is included in at least one embodiment of the present invention. Thus, appearances of the phrases “in one embodiment,” “in an embodiment,” “in embodiments” and similar language throughout this specification may, but do not necessarily, all refer to the same embodiment.

The terms “overlying” or “atop”, “positioned on” or “positioned atop”, “underlying”, “beneath” or “below” mean that a first element, such as a first structure (e.g., a first layer) is present on a second element, such as a second structure (e.g. a second layer) wherein intervening elements, such as an interface structure (e.g. interface layer) may be present between the first element and the second element.

As indicated above, aspects of the present invention generally relate to a device for protecting a rim of a vehicle/conveyance such as a bicycle, a motorcycle, an automobile, etc. In general, the device includes a ring for abutting and protecting an outside edge (along an outer circumference) of a rim, and a set of wings for securing the ring to the rim via insertion of the wings between the rim and a tire mounted on the rim. In one embodiment, the ring and/or each wing may be made of one or more materials such as a rubberized material, a plastic material, a composite material, or any combination thereof. Moreover, each wing typically comprises a wedge shape body having a set of engagement peaks for inserting and securing the wings between the tire and the wheel (e.g., before or after the tire has been mounted on the rim).

Before specific details of the protection device of the present invention are shown and described in greater detail, a background description and corresponding terminology for components of a tire and a rim will first be given.

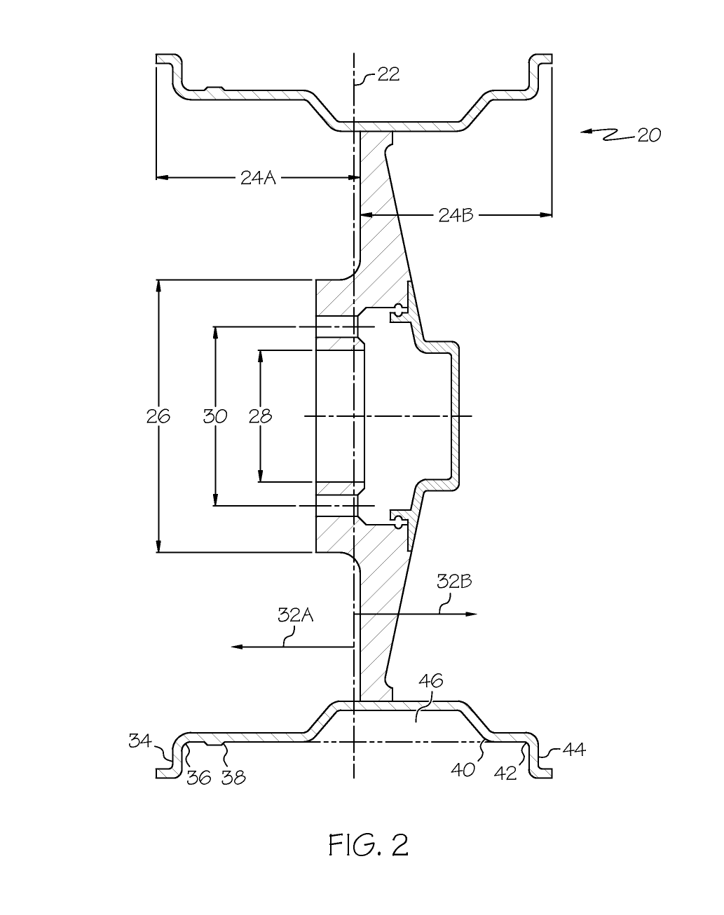

Referring now to FIG. 2, components of a rim 20 are shown in greater detail. It is understood that rim 20 is typically a rim utilized by an automobile. However, similar concepts could apply to other rim types such as those for bicycles, motorcycles, etc. Regardless, rim 20 typically comprises a wheel centerline 22, back spacing 24A, front spacing 24A-B, axel pad 26, center bore 28, bolt circle diameter 30, negative offset 32A, positive offset 32B, inboard flange 34, inboard bead seat 36, inboard safety hump 38, outboard safety hump 40, outboard beat seat 42, outboard flange 44, and drop center 46. These components are typically for engaging a tire component and/or axel component for securing a tire to a vehicle.

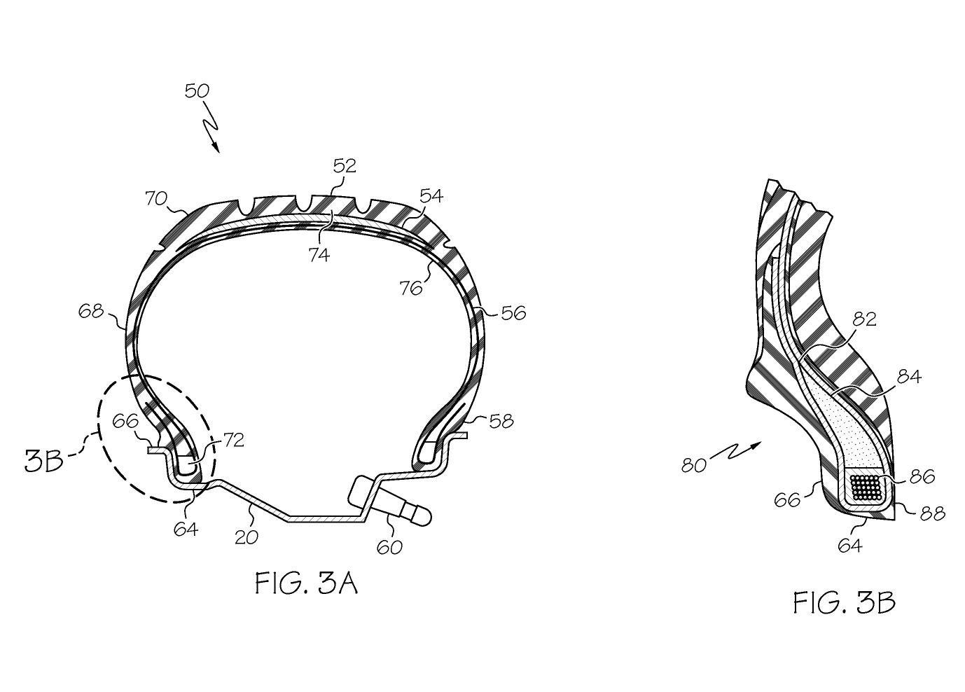

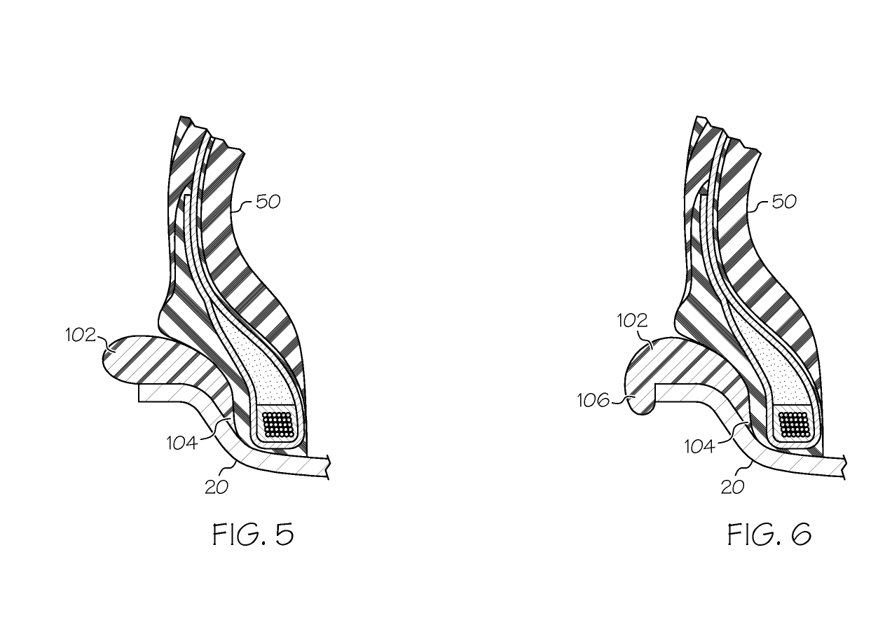

Referring to FIGS. 3A-B, components of a tire 50 are shown in greater detail. As depicted, tire 50 comprises tread 52, belt 54, carcass 56, protective rubber 58, snap-in valve 60, rim 20 (as mounted), bead base 64, bead heel 66, side wall 68, shoulder 70, bead core 72, under tread 74, and inner liner 76. FIG. 5B depicts a close-up of a car bead 80 (into which the protective device of the present invention will be fit). As shown, bead 80 comprises flipper 82, chafer 84, bead heel 66 (FIG. 3A), bead wire 86, bead toe 88, and bead base 64 (FIG. 3B).

In general, the sidewall represents the part of a tire between the shoulder and the bead. A flexible sidewall protects the carcass and enhances the ride. The bead attaches the tire to the rim and wraps the end of the cord fabric. The bead is generally designed to be slightly tight around the rim, so that in the case of a sudden drop in inflation pressure, the tire will not fall off the rim. The rim is the edge of a wheel, holding the tire. It makes up the outer circular design of the wheel on which the inside edge of the tire is mounted on vehicles such as automobiles. Modern passenger vehicles and tubeless tires typically use one-piece rims with a “safety” rim profile. The safety feature helps keep the tire bead held to the rim under adverse conditions by having a pair of safety humps extending inwardly of the rim toward the other tire bead seat from an outer contoured surface of the rim. The terms “wheel” and “rim” are often used synonymously, as in decorative wheels being called rims. Damage to the rim can cause vibration and cause the tire to fail to hold pressure.

The beads of a wheel are the flat areas just inside of the flanges where the edges of the tire (which are also called the beads) seat onto the wheel. It is important that the beads be kept clean, as old rubber or corrosion on the beads can affect how the tires seal. The beads and flanges are also important as the “energy transfer points” of the wheel. Because the tire seats directly against the beads and flanges, any major imperfection of those points, such as a bend in the wheel or a damaged tire bead, will transfer vibration from the wheel/tire combination directly into the suspension and can make the whole car shake at high speeds.

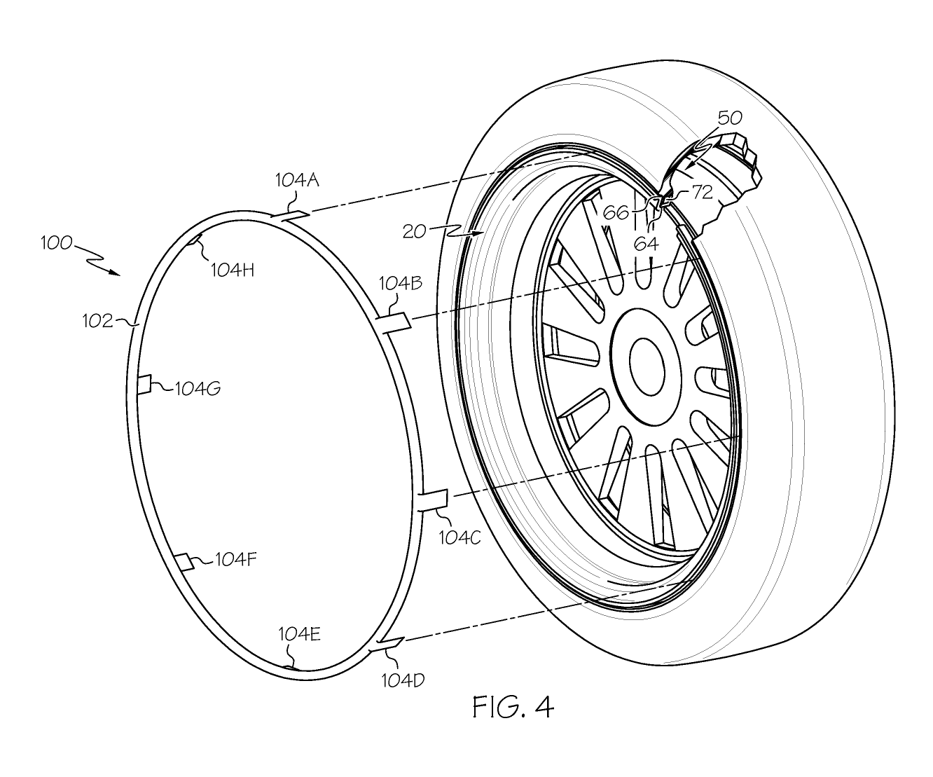

Referring now to FIG. 4, the incorporation of protective device 100 with rim 20 and tire 50 are shown. As depicted, device 100 generally comprises a ring 102 having a plurality of wings 104A-N affixed along a circumference thereof (at relatively equidistant positions). In general, wings 104A-N will extend laterally and/or radially from ring 102. Moreover, wings 104A-N will typically “snap” in between rim 20 (proximate the flange and/or seat) and tire 50 (e.g., proximate bead heel). Such integration may occur after tire 50 has already been mounted on rim 20.

Referring to FIG. 5, a more detailed diagram of device integration is shown. As depicted, wing 104 is inserted between rim 20 and tire 50. This will allow a protrusion of ring 102 to extend beyond rim 20 and tire 50 and absorb damage from foreign objects such as curbs. Another embodiment is shown in FIG. 6. As depicted, wing 104 is inserted between rim 20 and tire 50. However, in this embodiment, ring 102 can be fitted with a protected shell 106 to provide further securing to rim 20 and/or additional protection of components (e.g., rim 20, tire 50, and/or ring 102) from damage.

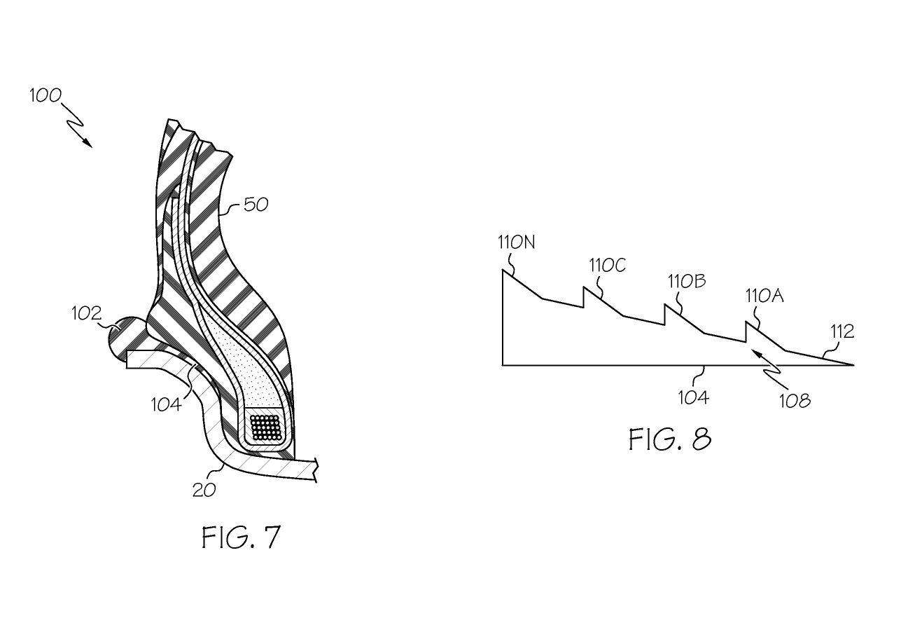

Referring to FIG. 7, it is shown that device 100 may be constructed of varying materials for improved functionality. For example, as shown, wing 104 may be constructed from a plastic or composite, while ring 102 may be constructed from a rubberized material. It is understood that these materials may be reversed, and/or a single material may be utilized for the entire device 100. Using a rubberized material having an elasticity factor may allow wing 104 (if the rubberized material is used on the wing) to be more easily inserted between rim 20 and tire 50. Moreover, a rubberized material may allow ring 102 (if used on ring 102) to absorb more damage from foreign objects.

Referring now to FIG. 8, a specific wing 104 configuration is shown. As depicted, wing 104 may generally have a wedge shape 108 and a series of engagement peaks 110A-N. The configuration allows for end 112 of wing 104 to be inserted between the rim and tire more easily (e.g., via narrower end 112 of wedge 108), and to be secured in place via engagement peaks 110A-N.

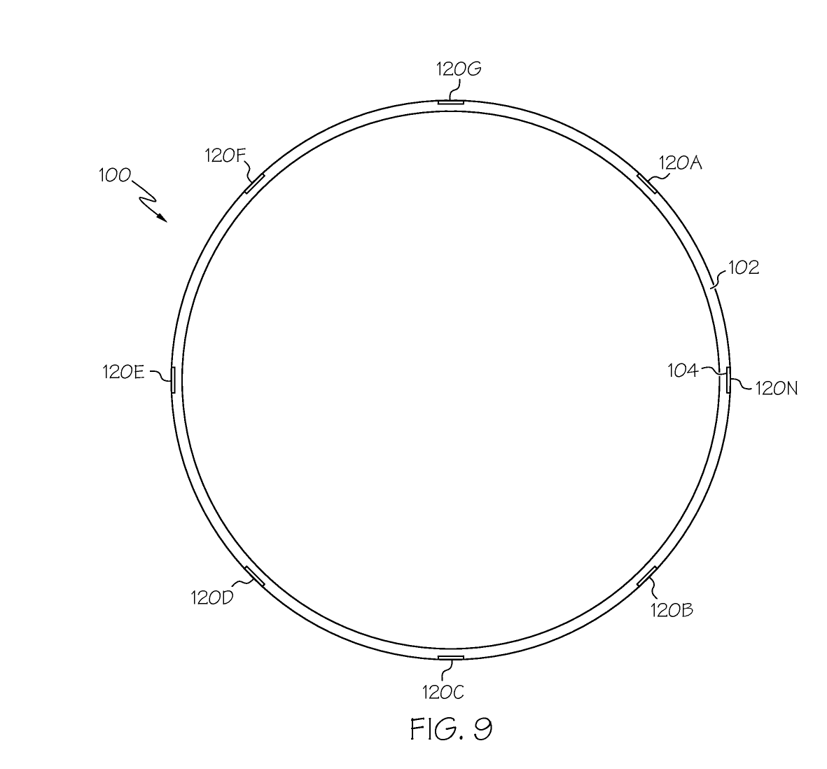

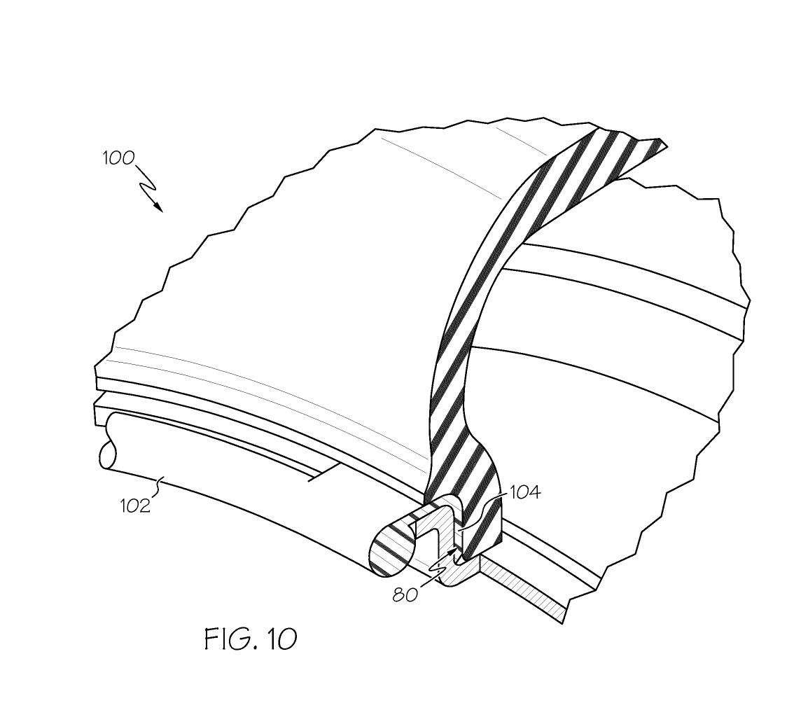

Referring now to FIG. 9, positioning of wings 104 (only one shown) along ring 102 of device 100 is shown. As depicted, a wing 104 will typically be positioned on wing along a circumference thereof. Moreover, wings 104 should be positioned at equidistant positions such as positions 120A-N. It is understood that although eight wing positions are shown in FIG. 9, this need not be the case. That is, a different quantity of wings could be provided. For example, a similar outcome could be produced from 2 wings, 4 wings, 7 wings, 10 wings, etc. In another embodiment, a single wing extending at least a portion of ring 102 could be provided. Regardless of the quantity of wings, each wing provided can have a wedge shape and engagement portion(s) such as that shown in FIG. 8.

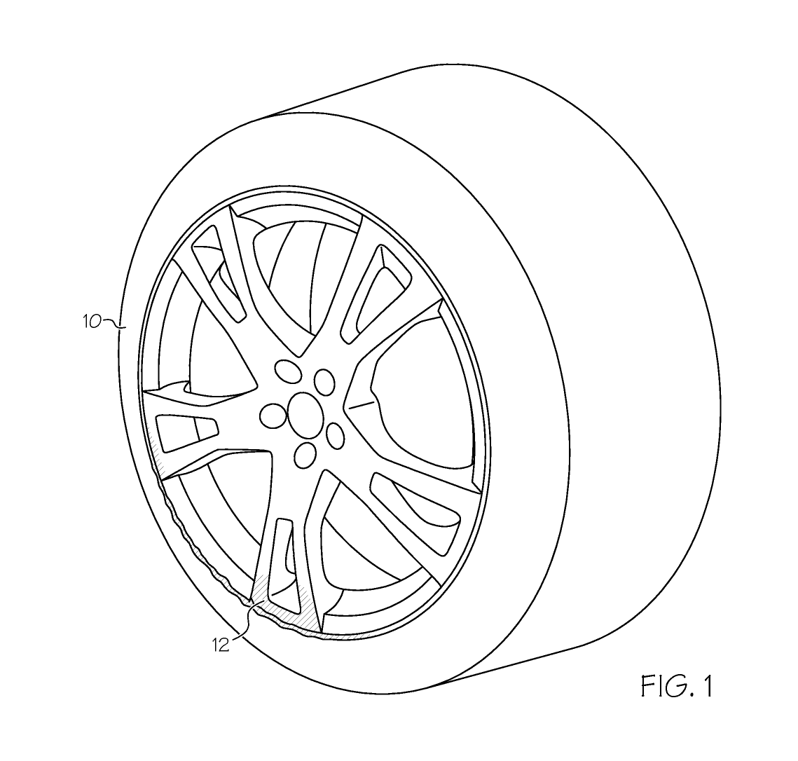

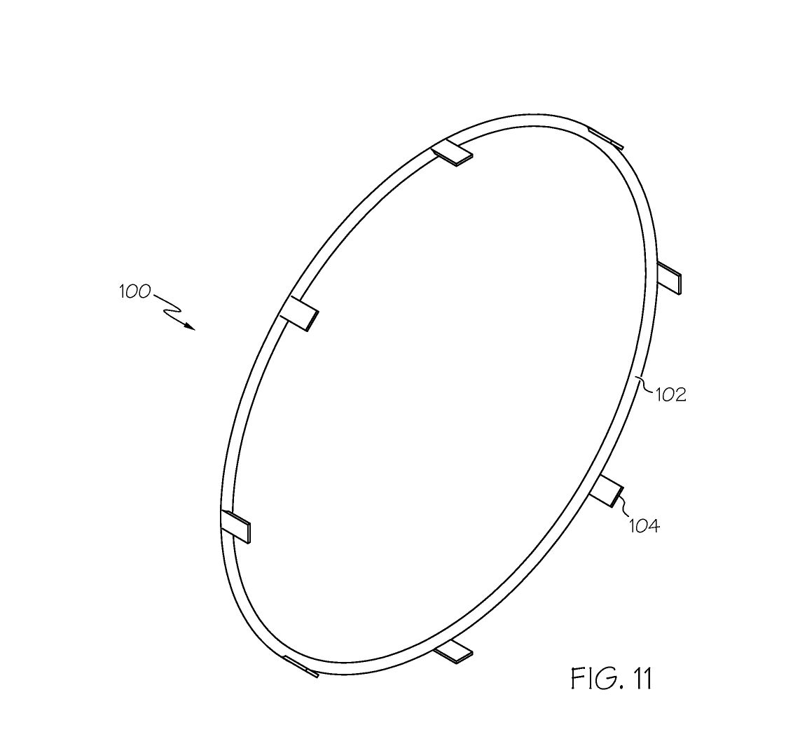

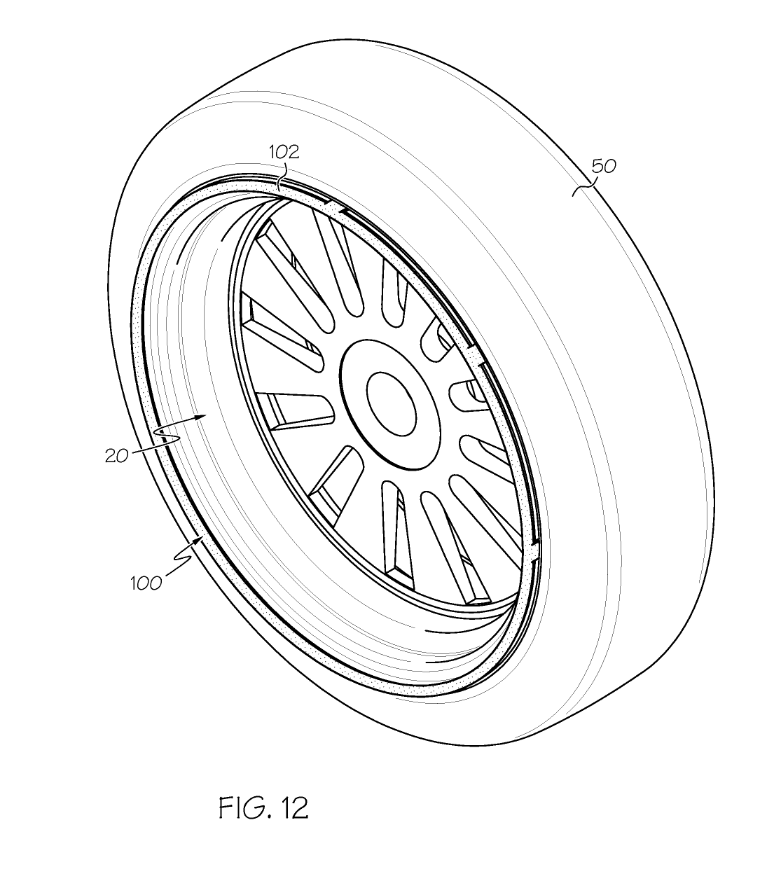

Referring to FIG. 10, the engagement of device 100 with bead 80 is shown in greater detail. As shown wing(s) generally extend laterally from ring 102 and are inserted between the bead heel 66 and the bead base 64 (as depicted in FIG. 5). An isometric view of device 100 is shown in FIG. 11. As can be seen, wing(s) 104 extend away from ring 102 for “snapping” or “insertion” in between a rim and tire (e.g., pre- or post-tire mounting). FIG. 12 shows device 100 as installed. As depicted, device 100 covers the outer edge of rim 20 as tire 50 is mounted thereon. In a typical embodiment, device 100 (or ring 102 thereof) will protrude out further than rim 20 and make contact with any foreign objects in lieu of rim making such contact. Thus, rim 20 will be protected from damage such as that shown in FIG. 1. It is understood that certain aesthetic choices may be incorporated within the teachings of the present invention. For example, device 100 may be made with various colors, logos, grooves, edges, etc.

While the invention has been particularly shown and described in conjunction with exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with the present invention. Furthermore, the methods according to the present invention may be implemented in association with the formation and/or processing of structures illustrated and described herein as well as in association with other structures not illustrated. Therefore, it is to be understood that the appended claims are intended to cover all such modifications and changes that fall within the true spirit of the invention.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A device for protecting a rim of a conveyance, comprising:
a ring; and
a set of wings affixed to the ring, wherein the set of wings are configured to engage between the rim of the conveyance and a tire of the conveyance to secure the ring to the rim after the tire has been mounted on the rim, and wherein at least a portion of the device comprising a rubberized material having an elasticity factor.

2. The device of claim 1, the set of wings comprising a wedge shape body having a set of engagement peaks for inserting and securing the set of wings between the tire and the wheel.

3. The device of claim 1, the set of wings engaging a portion of the tire between a bead hill and a bead base of the tire.

4. The device of claim 1, the ring engaging an outer portion of the rim to protect the rim when the vehicle is in operation.

5. The device of claim 1, the ring having a circumference proportional to a circumference of the rim.

6. The device of claim 1, the ring comprising a protective shell configured to protect an outer surface of the rim.

7. The device of claim 1, the plurality of wings extending laterally from the ring.

8. The device of claim 1, the set of rings being spaced at substantially equidistant positions along the ring.

9. A device for protecting a rim of a conveyance, comprising:
a ring; and
a plurality of wings affixed to the ring, wherein the plurality of wings are configured to engage between the rim of the conveyance and a tire of the conveyance to secure the ring to the rim after the tire has been mounted on the rim, and wherein the plurality of wings comprise a wedge shape body having a set of engagement peaks for inserting and securing the plurality of wings between the tire and the wheel.

10. The device of claim 9, at least a portion of the plurality of wings comprising a rubberized material having an elasticity factor.

11. The device of claim 9, the plurality of wings engaging a portion of the tire between a bead hill and a bead base of the tire.

12. The device of claim 9, the ring engaging an outer portion of the rim to protect the rim when the vehicle is in operation.

13. The device of claim 9, the ring having a circumference proportional to a circumference of the rim.

14. The device of claim 9, the ring comprising a protective shell configured to protect an outer surface of the rim.

15. The device of claim 9, the plurality of wings extending laterally from the ring.

16. The device of claim 9, the plurality of rings being spaced at substantially equidistant positions along the ring.

17. A device for protecting a rim of a conveyance, comprising:
a ring; and
a plurality of wings affixed radially to the ring, wherein the plurality of wings are configured to engage between the rim of the conveyance and a tire of the conveyance to secure the ring to the rim after the tire has been mounted on the rim, wherein the plurality of wings comprise a wedge shape body having a set of engagement peaks for inserting and securing the plurality of wings between the tire and the wheel, and wherein at least a portion of the plurality of wings comprising a rubberized material having an elasticity factor.

18. The device of claim 17, the plurality of wings engaging a portion of the tire between a bead hill and a bead base of the tire.

19. The device of claim 17, the ring engaging an outer portion of the rim to protect the rim when the vehicle is in operation.

20. The device of claim 17, the ring having a circumference proportional to a circumference of the rim.
